(19) United States
(12) Patent Application Publication
(10) Pub. No.: US 2020/0300055 A1
(43) Pub. Date: Sep. 24, 2020

(54) AUXILIARY EQUIPMENT PROVISION

(71) Applicant: GE Oil & Gas UK Limited, Bristol (GB)

(72) Inventors: Anthony Jason VANGASSE, Bristol (GB); Raymond PHILLIPS, Bristol (GB)

(21) Appl. No.: 16/761,895

(22) PCT Filed: Nov. 7, 2018
(86) PCT No.: PCT/EP2018/080503

§ 371 Date: May 6, 2020

(30) Foreign Application Priority Data
Nov. 17, 2017 (GB) 1719033.1

(51) Int. Cl. E21B 33/038; E21B 33/035; E21B 34/02; H04B 1/38; H01R 13/523

(52) U.S. Cl. CPC E21B 33/0385; E21B 33/0355; E21B 43/017; H04B 1/38; H01R 13/523; E21B 34/025

(57) ABSTRACT

A method and apparatus are disclosed for providing auxiliary equipment at a subsea location. The apparatus includes a housing including at least one wet mate receptacle connector and at least one wet mate plug connector spaced apart from the receptacle connector, at least one electronic auxiliary device in the housing, at least one connector member extending through a portion of the housing connecting at least one connection element of the wet receptacle connector to a respective at least one connection element of the wet plug connector; wherein the auxiliary device is connected to the connector member in the housing to thereby connect the auxiliary device to the connector member.

The present invention relates to a method and apparatus for providing auxiliary equipment at a subsea location. In particular, but not exclusively, the present invention relates to the use of a movable housing which contains an electronic auxiliary device such as a wireless transceiver unit, which can be secured between wet mating connectors provided by a Subsea Control Module (SCM) and an associated flying lead. Securing the housing in place simultaneously supports the electronic device at a desired location so it can communicate with a nearby sensor and electrically connects the device to power and/or a data bus provided by the SCM and/or flying lead.

It is known that from time to time an electronic auxiliary device is required at locations where such use was not initially planned/envisaged. Examples of such electronic auxiliary devices are manifold. For example, any electronic device that can be thought of as being capable of functioning independently remote from a main control unit is an electronic auxiliary device. Likewise, electronic devices that can be located remote from a main control unit and which can be connected, via a wired or wireless communication link to the main control unit can be thought of as an electronic auxiliary device. Examples are a wireless transceiver to communicate with remote sensors, a monitor unit for monitoring a local parameter, a remote controller, a line insulation monitor, or the like.

Often such electronic auxiliary devices would be desired at a subsea location where their introduction would be complicated and costly. For example, development of oil fields which are under water involves drilling a well on the sea bed. For those wells which are completed “subsea” the well is capped using a subsea tree. The subsea tree carries out multiple functions. One is to contain the natural pressure of a hydrocarbon reservoir and at least one further function is to control the flow of reservoir fluids from the well bore through a flow line to a subsea gathering facility. The control of flow is achieved with a number of control valves in the flow path of the fluids produced by the well. At least one of the control valves is a variable orifice type valve commonly known as a choke valve. Such a valve controls the rate of flow by causing a differential pressure drop across the choke valve between inlet and outlet.

Conventionally the subsea tree is connected to a subsea manifold using a subsea flow line referred to as a “jumper”. The manifold is arranged to collect hydrocarbon well bore fluids from several other wells where the collected fluids can be co-mingled into a common header. Such developments are often referred to as a manifold cluster development. The flow line jumper connection comprises a pipe that can be of a flexible type but may alternatively be a rigid pipe design using a zig-zag geometric shape. This helps provide a level of construction tolerance when connecting the tree to the manifold.

The subsea tree also contains a number of sensors for measurement of pressures and temperatures of the produced fluids and to detect a position or state of the flow control valves. Conventionally the tree assembly is controlled by a Subsea Control Module (SCM). This commands the flow control valves. This is often achieved using a solenoid controlled actuator to pilot hydraulic or electrically powered actuators. Conventionally the SCM contains control electronics to generate flow control commands and also provide a data multiplexing capability for digitising inputs from the on-tree sensors and the measurements are used for the purposes of monitoring and reporting or comparison and decision making.

Conventionally an SCM has been equipped with at least one Subsea Electronics Module (SEM). The SEM has conventionally provided a data acquisitions/data multiplexing service to a number of sensors. Such sensors have been sensors for pressure and/or temperature and/or valve position or other parameters and have been disposed around the tree. Conventionally there have been multiple types of interface between the sensors and the SEM. Conventionally one such communication technique between an SEM and sensors around a subsea location have been the inclusion of an interface card provided within an SEM enclosure to transfer data from a sensor using connection wires which pass into the SCM and subsea electronics module via a multi-way wet mating connector. Such wet mating connectors have conventionally been provided on a top surface on an SCM providing communication to an interface card internal to the SEM. Wet mating connectors may also be fitted on a top surface of a subsea power-switching and communications-routing module or in other subsea locations.

Multi-way wet mating connectors are thus well known. These typically have two parts. A first fixed part which can be secured to a top surface of an SCM for example and a removable part which conventionally has optionally been integrated with an interconnection harness. Various types of wet mate connector are shown in a wet mate connector market study prepared for ORE Catapult doc ref 2500014-01-D-3-001 dated 21 Mar. 2014. This has been produced by Wood Group Kenny.

The fixed wet mating connector is referred to hereinafter as a receptacle. This can be thought of as a “female” socket. Multiple connections may be made via respective wired or fibre pins/ports carried by the receptacle wet mate connector. The removable wet mating connector is referred to hereinafter as a “flying” element. This may be a plug-like element and can thus be thought of as a “male” element. Multiple connections may be made via respective wired or fibre port/pins carried by the plug wet mate connector. It will be appreciated that the female receptacle can carry male or female connections although typically the receptacle wet mate connector presents female connection ports. Likewise, the male plug wet mate connector can carry male or female connections although typically the plug wet mate connector presents male connection pins. It will likewise be appreciated for the avoidance of doubt that the wet mating connectors can be reversed so that the receptacle part can terminate a flying lead and a plug wet mate connector can be fixed.

Conventionally a type of sensor interface linking an SEM to a remote sensor or sensor array has included a data-bus interface via a shared two-wire or four-wire system which can optionally be connected to a number of sensors connected to the data and power bus. The subsea industry has begun standardising this data highway connection as “SIIS-Subsea Instrumentation Interface Standardisation which is being defined by the international standard from the API 17F Rev 3.

Conventionally when a new sensor or control element not originally envisaged when an SCM is first secured in place at a subsea tree is to be added at a subsea location the SCM must first be recovered and electrical connections in the SCM reconfigured to make connection to a duly located sensor. This can be a complicated and time consuming and thus costly process.

Sometimes an upper surface of an SCM does not physically have any room for additional connectors for conventional wired connections to newly desired electronic devices. Likewise, sometimes new equipment such as sensors or controllers are needed at a location that is too far away from the fixed location of an SCM to use a wired connection.

It is an aim of the present invention to at least partly mitigate the above-mentioned problems.

It is an aim of certain embodiments of the present invention to provide a method and apparatus for providing auxiliary equipment at a subsea location in a convenient manner.

It is an aim of certain embodiments of the present invention to enable an adapter unit formed as a housing which includes at least one electronic auxiliary device such as a wireless transceiver, to be connected conveniently by interposing the adapter unit between opposed wet mating connectors.

It is an aim of certain embodiments of the present invention to provide a method and apparatus for retrofitting auxiliary equipment at a subsea location where the auxiliary equipment can be chosen according to need and conveniently secured in place simultaneously providing the auxiliary device together with any needed electrical contacts and power at a fixed desired position.

It is an aim of certain embodiments of the present invention to enable an owner of a subsea production system installation to conveniently add sensors to a facility after that facility has been installed and is operating.

It is an aim of certain embodiments of the present invention to enable wireless communication sensors to be accommodated together with conventional wired connections.

According to a first aspect of the present invention there is provided apparatus for providing auxiliary equipment at a subsea location, comprising:
a housing including at least one wet mate receptacle connector and at least one wet mate plug connector spaced apart from the receptacle connector;
at least one electronic auxiliary device in the housing;
at least one connector member extending through a portion of the housing connecting at least one connection element of the wet receptacle connector to a respective at least one connection element of the wet plug connector; wherein
the auxiliary device is connected to the connector member in the housing to thereby connect the auxiliary device to the connector member.

Aptly the auxiliary device comprises a wireless communication device.

Aptly the wireless communication device comprises an acoustic or optical or radio frequency communication device.

Aptly the wireless communication device comprises a wireless receiver element for receiving data transmitted via a wireless communication link from at least one sensor remote from said housing.

Aptly the wireless communication device comprises a wireless transmitter element for transmitting data to at least one remote sensor via a wireless communication link.

Aptly the housing provides an adaptor unit securable between wet mating connectors of a subsea fixture and an associated flying lead respectively.

Aptly the connector member comprises a wired data bus and/or power rail.

Aptly the at least one connector member comprises an optical fibre element.

Aptly the auxiliary device is connected to the at least one connection element of a wet receptacle connector and the at least one connection element of the wet plug connector via a wired and/or optical connection.

Aptly the housing is a water resistant and pressure resistant housing.

Aptly the wet mate receptacle connector is on an upper external surface of the housing and the wet mate plug connector is on a lower external surface of the housing.

Aptly the subsea location comprises a subsea production system installation that comprises a Subsea Control Module (SCM) and the SCM comprises the at least one wet mate receptacle connector.

According to a second aspect of the present invention there is provided a method of retro fitting auxiliary equipment at a subsea location, comprising the steps of:
disconnecting a flying lead, terminated by a flying lead wet mate plug connector, from a subsea fixture comprising at least one subsea fixture wet mate receptacle connector;
securing a housing containing at least one electronic auxiliary device to the subsea fixture by securing a housing wet mate plug connector of the housing to the subsea fixture wet mate receptacle connector; and re-connecting the flying lead wet mate plug connector to a housing wet mate receptacle connector of the housing.
Aptly the method further comprises electrically connecting the electronic auxiliary device to a power supply by securing the housing between the flying lead and subsea fixture.

Aptly the method further comprises connecting the electronic auxiliary device to a data communication pathway extending between the subsea fixture and the flying lead by securing the housing between the flying lead and the subsea fixture thereby locating at least one connector member of the housing in communication with the subsea fixture and/or the flying head and the electronic auxiliary device.

Aptly the method further comprises receiving data from or transmitting data to a sensor element remote from the subsea fixture via the electronic auxiliary device.

Aptly the method further comprises providing data to be transmitted wirelessly from the electronic auxiliary device to the electronic auxiliary device via a processor element of the subsea fixture or a processor element connected to the electronic auxiliary device via the flying lead.

Aptly the method further comprises providing data received wirelessly at the electronic auxiliary device to a processor element in the subsea fixture or a processor element connected to the electronic auxiliary device via the flying lead.

Aptly the method further comprises wirelessly communicating between the electronic auxiliary device and a sensor remote from the electronic auxiliary device via acoustic and/or optical and/or radio frequency wireless communication.

Aptly the method further comprises disconnecting and subsequently reconnecting the flying lead wet mating connector via an ROV or AUV or diver.

According to a third aspect of the present invention there is provided a method of retrieving and/or replacing a subsea adaptor comprising a housing containing a first electronic auxiliary device and at least one wet mate receptacle connector and at least one wet mate plug connector, comprising the steps of:
via an ROV or AUV or diver, disconnecting a flying lead terminated in a flying lead wet mate plug connector from a first housing containing an associated first electronic auxiliary device;
disconnecting the first housing from a subsea fixture by unsecuring a housing wet mate plug connector from a subsea fixture wet mate receptacle connector; and
retrieving the first housing via the ROV or AUV or diver and/or replacing the first housing with a further housing containing an associated at least one further electronic auxiliary device via the ROV or AUV or diver.

Certain embodiments of the present invention enable auxiliary equipment, such as a transceiver unit or other such electronic auxiliary device able to communicate with a remote sensor via a wireless communication link, to be provided at a subsea location.

Certain embodiments of the present invention enable various forms of electronic auxiliary devices to be retrofitted to an SCM at a subsea tree without having to first recover the SCM.

Certain embodiments of the present invention provide a wireless “adapter unit” that can provide a wireless communication link to a remote sensor or controller and which can conveniently connect to existing sensor interface circuitry such as a data bus and/or power rail via an interface module.

Certain embodiments of the present invention provide an “on board” electronic auxiliary device and associated interface module in a common housing that can be interposed between conventional wet mate connectors to thereby connect to an SCM and/or flying lead in a “plug-and-play” fashion.

Certain embodiments of the present invention will now be described hereinafter, by way of example only, with reference to the accompanying drawings in which:

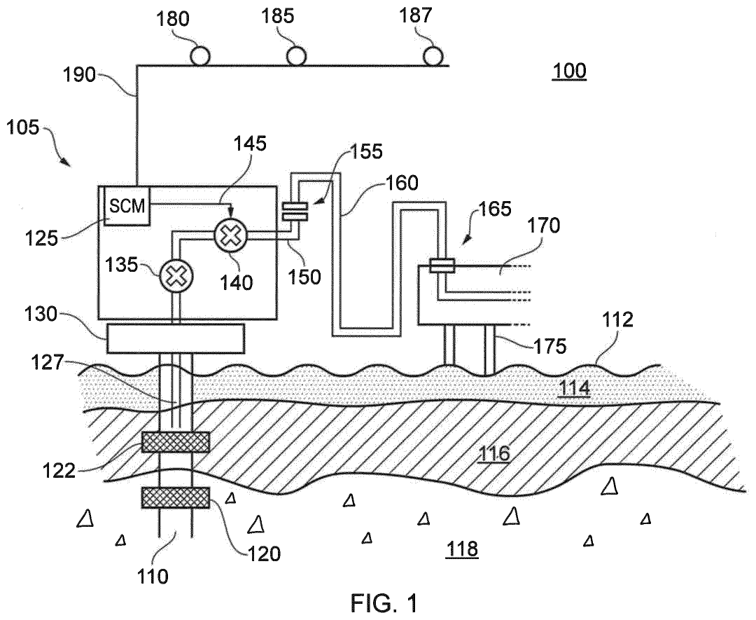

FIG. 1 illustrates a subsea environment;

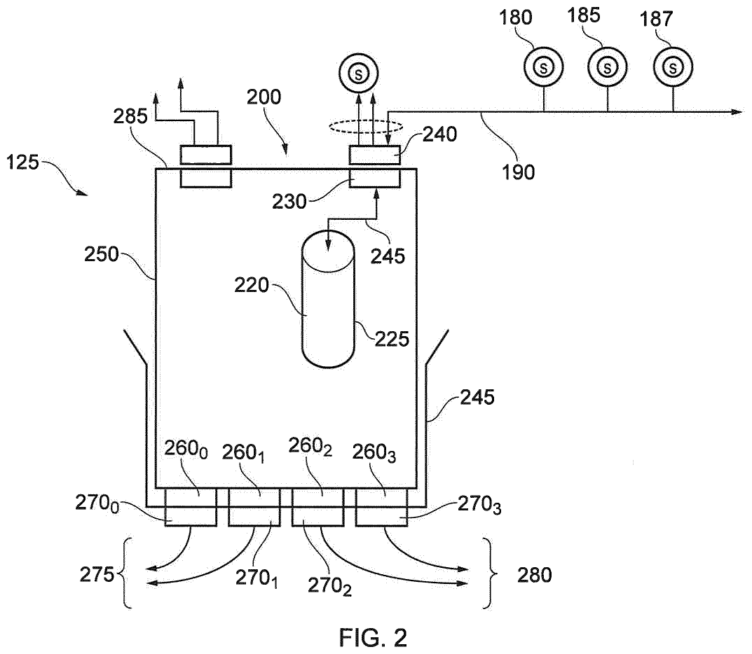

FIG. 2 helps illustrate the SCM and wet connectors shown in FIG. 1;

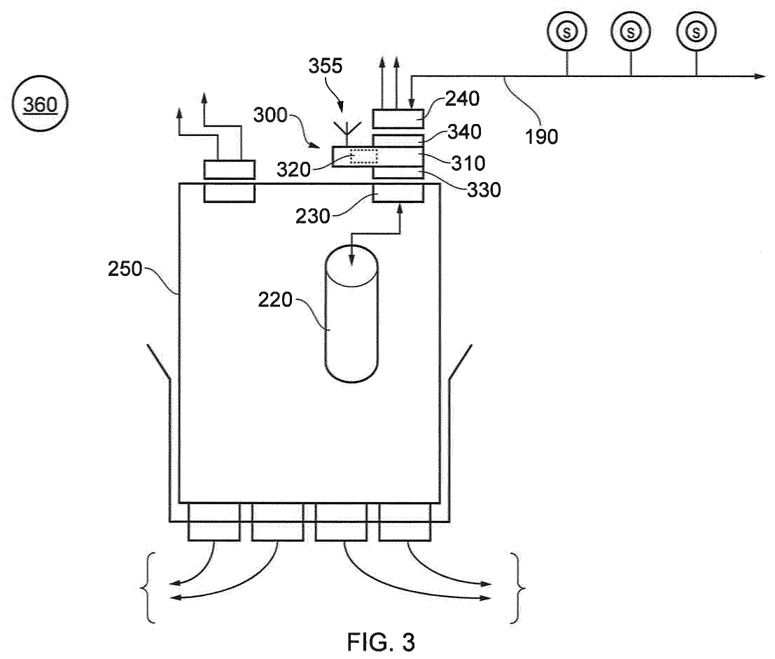

FIG. 3 illustrates the wet connectors of the SCM connected to an interposed adapter unit;

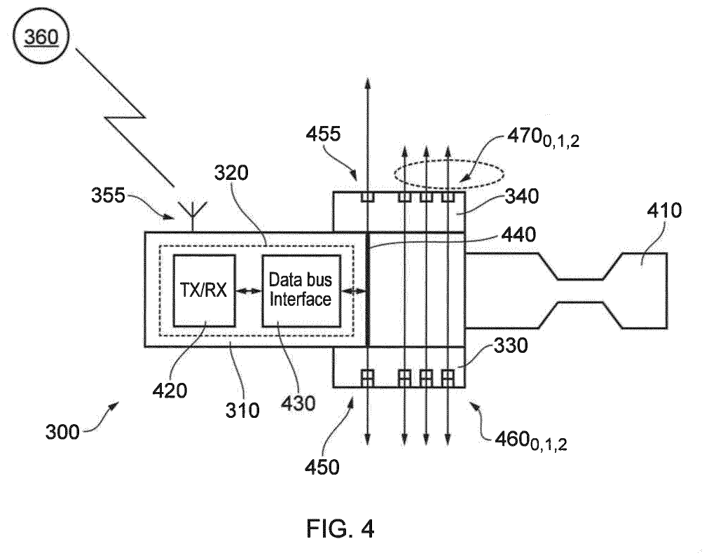

FIG. 4 schematically illustrates an adapter unit;

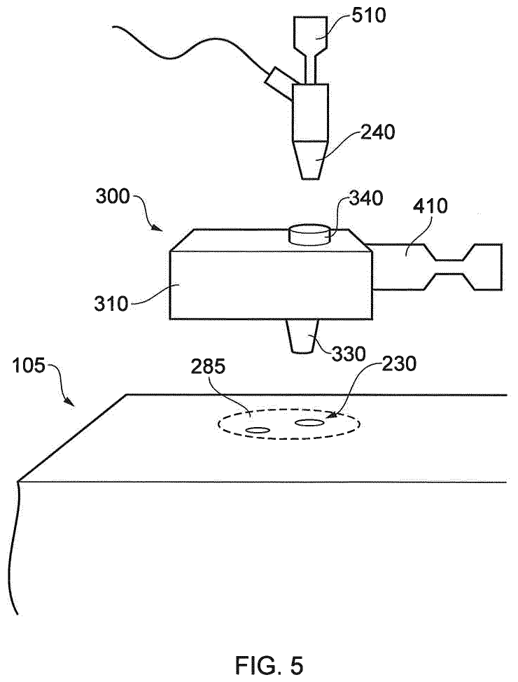

FIG. 5 schematically illustrates an adapter unit being secured between an SCM and a flying lead; and

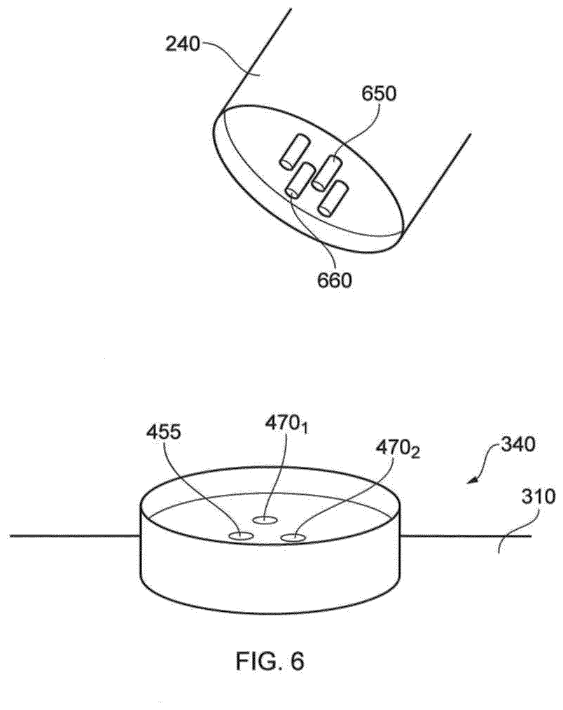

FIG. 6 illustrates male and female connection elements in the form of pins and ports of a wet mating plug and receptacle.

In the drawings like reference numerals refer to like parts.

FIG. 1 illustrates a particular subsea environment 100. It will be appreciated that embodiments of the present invention are not restricted to use at such locations but are more generally applicable wherever an electronic auxiliary device is desired at a particular location where wet mating connectors are present. In particular FIG. 1 illustrates a location of a subsea tree 105 which is located above a well bore 110 penetrating the sea bed 112. The well bore 110 passes through multiple layers under the sea bed 112. For example, as shown in FIG. 1, a first layer 114 immediately below the sea bed 112 comprises a band of material having a high sand content. A further layer 116 below the first layer 114 holds less sand. A still further layer 118 lies below the further layer 116 and holds little or no sand content. A hydrocarbon reserve may be found in a layer or in a region bridging multiple layers. It will be appreciated that the relative depths, thicknesses and sand/rock content will be different for each well bore location.

The well bore 110 passes through multiple layers and may pass many hundreds of meters or even more under the sea bed. The well bore 110 illustrated in FIG. 1 includes a first collar valve 120 in the deep layer 118 and a further collar valve 122 in the middle layer 116 shown in FIG. 1. Each collar valve 120, 122 is a selection element which effectively opens and closes under control of a Subsea Control Module (SCM) 125 in the subsea tree 105. By selectively controlling the open/closed status or, optionally, the partially open status of a respective collar valve 120, 122 liquid or gaseous components from the respective layers 116 can be gathered into the well bore region which contains a respective well bore production tubing 127. In this way a composition of fluid (proportion of gas or liquid or gas and liquid) can be selected. The fluid is thus multiphase in the sense that it can include different compositions of oil, gas, water and solid (sand or fine rock). It will be appreciated that certain embodiments of the present invention may include only a single bore with no collar valves in which case a composition of fluid flowing along a fluid flow pathway may be selected in other ways.

The subsea tree 105 is secured to a well head 130. This secures the subsea tree at a fixed desired location with respect to the sea bed 112. The well bore production tubing 127 passes through the well head into the subsea tree via an on/off flow isolation valve 135. This can be controlled via the SCM 125 to selectively permit fluid from the well bore production tubing 127 to flow to a desired downstream location via a fluid flow pathway which provides a fluid communication route.

As illustrated in FIG. 1 the subsea tree further includes a choke valve 140. This valve can selectively open and close or be partially opened using a variable orifice element to fully or partially constrain fluid flow along the fluid flow pathway. In this way the choke valve 140 governs flow rate, and thus an operational parameter of fluid flowing along a fluid flow pathway. Other types of governor element can of course be utilised dependent upon the operational parameter being governed. The choke valve 140 receives a control signal via a respective connection 145, from an SCM 125. In this way selection of the opening provided by the choke valve 140 can vary the fluid flowing along a fluid flow pathway. The choke valve is an example of an element that can select a flow rate or other parameter and which can be controlled via an input signal.

It will be appreciated that whilst an embodiment of the present invention has been described with respect to control using an SCM certain other embodiments of the present invention permit control via a ‘Top Side’ controller. For example, the subsea tree 105 can be connected via one or more umbilicals to a Topside Umbilical Termination Assembly (TUTA) of an Floating Production Storage and Offloading (FPSO) facility. Two way communication between a Master Control Station (MCS) and the subsea tree 105 can be provided by conventional techniques.

As illustrated in FIG. 1 the pipe work 150 which helps define the fluid flow pathway is generally a rigid structure within the subsea tree. This is connected via a respective flow line connector 155 to a respective jumper 160. The jumper 160 shown in FIG. 1 is a rigid jumper although it will be appreciated that a flexible pipe may alternatively be utilised. A first end of the jumper 160 is connected to the connector 155 of the subsea tree 105. A further end of the jumper 160 is connected to a respective flow line connector 165 of a manifold 170. The manifold 170 is secured to the sea bed via respective manifold support legs 175. Other connectors can be supported on the manifold 170 and these are connected via respective jumpers to other subsea trees (not shown in FIG. 1). The output from the manifold 170 flows along a single exit pipeline. The composition of the fluid flowing along the exit pipeline may be a combination of fluid from multiple subsea trees and that composition may be mixed by allowing fluid from multiple jumpers to flow into the manifold simultaneously. Alternatively, the output along the exit pipe may merely be fluid flowing from a single subsea tree.

FIG. 1 also helps illustrate how multiple sensors 180, 185, 187 can be located to detect respective parameters in the subsea environment. Sensors can be located in additional or alternative locations to detect a parameter in sea water or on a fixture in other locations. The sensors shown are connected to the SCM via a “harness” 190. Other techniques for providing wired and/or wireless connection could of course be utilised.

FIG. 2 illustrates the Subsea Control Module (SCM) 125 in the subsea tree 105 in more detail. As illustrated in FIG. 2 each sensor 180, 185, 187 is connected via a respective wired connection 190 to a sealed, wet mating connector interface region 200 at the top of the SCM. The SCM receives electrical power, communication signals, and hydraulic power supplies from surface control equipment via an umbilical (not shown). Redundant supply of communication signals and electrical and hydraulic power may be likewise transmitted through a corresponding umbilical copper core or hose connecting a top side to the subsea tree. The umbilical hose length may be a few hundred meters up to potentially many kilometers in length linking the subsea environment to surface equipment. The SCM is utilised to help distribute power to solenoid piloting valves, pressure transducers and temperature transducers in the subsea tree which can be utilised to control the flow isolation valve 135 and choke valve 140.

A Subsea Electronics Module (SEM) 220 is located within the SCM 125. The SEM is a sealed unit, held at a selected pressure, and containing electronic assemblies which are fed with on board power from a power source (not shown). The SEM has a housing 225 with a connection to a respective wet mating connector 230. The SEM is connected to the wet mating connector 230 which in the example shown is a receptacle wet mating connector which includes multiple female parts to receive corresponding pins of a plug wet mating connector 240. The SEM is connected to the receptacle wet mating connector 230 via a wired connection 245 in the SCM 125.

FIG. 2 helps illustrate how the SCM 125 is secured in an SCM mounting base 245. This enables the SCM to be recovered by an ROV or AUV or diver as required. When an SCM is introduced into the tree the container body 250 of the SCM is introduced into the open mouth of the mounting base 245 and multiple wet mating connectors 260_{0,1,2,3} on a lower surface of the SCM simultaneously engage with corresponding reciprocating wet mating receptors 270_{0,1,2,3} which are provided on the SCM mounting base 245. In this way an SCM can simultaneously be duly located and secured in place in the SCM mounting base and electrical and/or optical and/or other types of connection can automatically be created. For example, as shown in the example illustrated schematically with respect to FIG. 2 the first and second wet mating connector pairs 260₀, 270₀, 260₁, 270₁ can be utilised to provide multiple electrical connections 275 within the subsea tree. The third and fourth pairs of wet mating connectors 260₂, 270₂, 260₃, 270₃ can be utilised to provide multiple hydraulic connections 280 for use in the subsea tree.

FIG. 2 thus helps illustrate how wet mating connectors on a lower surface of a SCM can be utilised to enable an SCM to be recovered and/or duly put in place at a subsea tree simultaneously making electrical and/or hydraulic and/or optical connections as required for use at the subsea tree. An upper surface 285 of the SCM (or other accessible surface) which is left revealed when the SCM is duly located in an SCM mounting base of a subsea tree likewise provides a wet mating connector region 200 where multiple fixed wet mating receptacles are located which can be selectively connected via flying leads terminated in a respective wet mating connector to the SCM. It will be appreciated that the wet mating connectors on the upper surface 285 of the SCM can be configured according to need/choice but changes to such configuration requires an SCM to be recovered.

FIG. 3 helps illustrate how an adapter unit 300 can be interposed between a fixed wet mating connector 230 and a flying wet mating connector 240. The adapter unit 300 provides apparatus for providing auxiliary equipment at a subsea location. The adapter unit 300 includes a housing 310 which can contain at least one electronic auxiliary device 320. The housing 310 also carries a wet mate plug connector 330 and a wet mate receptacle connector 340. The wet mate plug connector 330 of the housing can connect with a corresponding receptacle wet mate connector 230 on the upper surface of the SCM whilst the receptacle wet mate connector 340 of the adapter unit can make a corresponding mating connection with the plug wet mating connector 240. In this way the adapter unit can be secured in place between opposing wet mating connectors. The interposition of the adapter unit between wet mating connectors both secures the adapter at a desired physical location with respect to the SCM and likewise makes electrical/optical/hydraulic or other connection through the adapter unit. In this way for example the harness 190 and associated sensors will still be provided with any connection needed to enable those sensors to be duly utilised.

As illustrated in FIG. 3 the adapter unit 300 can optionally include an antenna 355 on the external surface of the housing 310. Via the electronic auxiliary device 320 in the housing the antenna 355 can be used to communicate wirelessly with a slave device such as a sensor 360 which is remote from the SCM but local enough for wireless communication with the antenna 355. It will be appreciated by those skilled in the art that a suitable antenna 355 may optionally rather be included within the housing 310.

FIG. 4 helps illustrate the adapter unit 300 in more detail. The adapter unit is apparatus for providing auxiliary equipment at a subsea location. The adapter unit 300 includes a housing 310 which is waterproof and pressure resistant to enable the adapter unit to be duly located at a subsea location which may be a deep water subsea location. Aptly the housing is waterproof and pressure resistant to a depth of 1 km or more under the sea. The housing 310 carries a handle 410 which can be manipulated by an ROV. It will be appreciated that any form of carrying element can be provided to the adapter to enable a ROV or AUV or diver to duly locate the adapter unit at a desired location and mate it to wet mating connectors near an SCM or other such location.

As illustrated in FIG. 4 by way of example the adapter unit can include an electronic auxiliary device. In the example shown in FIG. 4 the electronic auxiliary device includes a transceiver 420 which is connectable to the antenna 355 and an associated data bus interface 430.

In the example shown in FIG. 4 the data bus interface is connected to a data bus connector 440 which runs through the housing connecting to a respective connection element 450 of the plug wet mate connector 330 carried by the housing and a connection element 455 of the receptacle wet mate connector 340. The data bus connector is an example of a connector member that extends through the housing connecting connection elements.

FIG. 4 helps illustrate how the housing 310 incorporates three additional through connectors which connect respective connection elements 460_{0,1,2} of the plug wet mate connector 330 to corresponding connection elements 470_{0,1,2} of the receptacle wet mate connector carried by the housing. In this way when the adapter is duly secured to the receptacle wet mate connector of the SCM via the plug wet mating connector 330 the connection elements 450, 460 of the plug wet mating connector 330 of the adapter unit make a data bus and electrical contact to the corresponding connection elements 455, 470 of the receptacle wet mating connector 340 of the adapter unit. When a flying lead including the plug type wet mating connector 240 is thereafter connected to the receptacle wet mating connector 340 of the adapter unit a through connection is made for the data bus and electrical connections. It will be appreciated that through connections can be made for any number and type of communication through the adapter unit. For example, the through connector can be an electrical connector for power or a data bus or a hydraulic through connector for hydraulic fluid or an optical connector for an optical fibre system. Other connection methodologies can of course be envisaged. One, two, three or more connection elements can be utilised per wet mating connector.

FIG. 5 helps illustrate how the adapter unit 300 may be moved into place by an ROV holding handle 410 so that a plug wet mate connector 330 carried by the housing can be duly located into a corresponding receptacle wet mate connector 230 in the upper surface 285 of the SCM 125. Once duly located a flying lead terminated in a plug wet mating connector 240 can likewise be manipulated by a respective handle 510 to make corresponding connections.

FIG. 6 helps illustrate the connection elements 455, 470 of the receptacle wet mating connector 340 on the housing 310 of the adapter unit in more detail. As can be seen these connection elements are a port-like (or “female”) connection element.

These duly engage with respective pin-like connection elements 650, 660 of the plug wet mating connector 240. It will be appreciated that any or all of the wet mating connectors previously described could include a latching element of a conventional type to ensure that duly mated plug and receptacle elements and their respective connections remain secured until released via a unlatching step.

Certain embodiments of the present invention have been described hereinabove with reference to implementation of a system at a “green field site”. That is to say where the characteristics of subsea structures are clearly defined by virtue of them being newly designed and constructed. Here an adapter unit can be utilised where it is envisaged that changes to local sensors may be needed in the near or long term future.

However certain embodiments of the present invention are usable at so-called “brown field sites”. Such a site may have been in operation for varying purposes over a significant period of time. Data associated with a subsea structure or multiple subsea structures at such a brown field site may never have been recorded or may now be lost. Alternatively over time modifications or wear and tear of the subsea structure may have varied resonance frequency details for the subsea structure. Here an adapter unit can be conveniently introduced as needed.

It will be appreciated that whilst a controller and associated data store have been described as part of the SEM 220 of an SCM 125, as an alternative that “intelligence” may be provided top side with the acoustic sensor outputs being provided via an umbilical data connection to a top side controller. Thereafter control signals from the top side controller can be provided via the umbilical to the SCM to control a state of the choke valve 140 and a sensor or other electronic element wirelessly connected to the adapter unit.

Certain embodiments of the present invention thus help provide an additional interface to sensors for practical and economic reasons relative to conventional techniques. Subsea wireless data connection can be provided with an adapter unit which is introduced between mating halves of a wet mating subsea electrical connector. In this way the adapter unit can be installed to connect firstly to a lower half of a wet mating subsea electrical connector picking up on existing data and power circuit within the connector shell. The upper half of the wet mating subsea electrical connector is connected to the upper surface of the adapter unit where it can then re-connect to an identical connector half to that originally provided on the top surface of the SCM. The adapter unit can optionally host various wireless technology solutions such as acoustic, free space optical, electromagnetic radiofrequency solutions. Aptly the adapter unit can host active electronics which take power from the electric circuit connections which pass through it and similarly connect to the data highways which pass through it.

Certain embodiments thus help provide for a connection of additional sensors at a subsea location which is facilitated even though there are physical limitations posed by existing legacy connection schemes. This can be achieved with minimal capital or installation cost as an SCM does not need to be retrieved to the surface to make changes.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for providing auxiliary equipment at a subsea location, comprising:
a housing including at least one wet mate receptacle connector and at least one wet mate plug connector spaced apart from the receptacle connector;
at least one electronic auxiliary device in the housing;
at least one connector member extending through a portion of the housing connecting at least one connection element of the wet receptacle connector to a respective at least one connection element of the wet plug connector; wherein
the auxiliary device is connected to the connector member in the housing to thereby connect the auxiliary device to the connector member.

2. The apparatus as claimed in claim 1, further comprising:
the auxiliary device comprises a wireless communication device.

3. The apparatus as claimed in claim 2, further comprising:
the wireless communication device comprises an acoustic or optical or radio frequency communication device.

4. The apparatus as claimed in claim 2, further comprising:
the wireless communication device comprises a wireless receiver element for receiving data transmitted via a wireless communication link from at least one sensor remote from said housing.

5. The apparatus as claimed in claim 2, further comprising:
the wireless communication device comprises a wireless transmitter element for transmitting data to at least one remote sensor via a wireless communication link.

6. The apparatus as claimed in claim 1, further comprising:
the housing provides an adaptor unit securable between wet mating connectors of a subsea fixture and an associated flying lead respectively.

7. The apparatus as claimed in claim 1, further comprising:
the connector member comprises a wired data bus and/or power rail.

8. The apparatus as claimed in claim 1, further comprising:
the at least one connector member comprises an optical fibre element.

9. The apparatus as claimed in claim 1, further comprising:
the auxiliary device is connected to the at least one connection element of a wet receptacle connector and the at least one connection element of the wet plug connector via a wired and/or optical connection.

10. The apparatus as claimed in claim 1, further comprising:
the housing is a water resistant and pressure resistant housing.

11. The apparatus as claimed in claim 1, further comprising:
the wet mate receptacle connector is on an upper external surface of the housing and the wet mate plug connector is on a lower external surface of the housing.

12. The apparatus as claimed in claim 1, further comprising:
the subsea location comprises a subsea production system installation that comprises a Subsea Control Module (SCM) and the SCM comprises the at least one wet mate receptacle connector.

13. A method of retro fitting auxiliary equipment at a subsea location, comprising the steps of:
disconnecting a flying lead, terminated by a flying lead wet mate plug connector, from a subsea fixture comprising at least one subsea fixture wet mate receptacle connector;
securing a housing containing at least one electronic auxiliary device to the subsea fixture by securing a housing wet mate plug connector of the housing to the subsea fixture wet mate receptacle connector; and
re-connecting the flying lead wet mate plug connector to a housing wet mate receptacle connector of the housing.

14. The method as claimed in claim 13, further comprising:
electrically connecting the electronic auxiliary device to a power supply by securing the housing between the flying lead and subsea fixture.

15. The method as claimed in claim 13, further comprising:
connecting the electronic auxiliary device to a data communication pathway extending between the subsea fixture and the flying lead by securing the housing between the flying lead and the subsea fixture thereby locating at least one connector member of the housing in communication with the subsea fixture and/or the flying head and the electronic auxiliary device.

16. The method as claimed in claim 13, further comprising:
receiving data from or transmitting data to a sensor element remote from the subsea fixture via the electronic auxiliary device.

17. The method as claimed in claim 16, further comprising:
providing data to be transmitted wirelessly from the electronic auxiliary device to the electronic auxiliary device via a processor element of the subsea fixture or a processor element connected to the electronic auxiliary device via the flying lead.

18. The method as claimed in claim 16, further comprising:
providing data received wirelessly at the electronic auxiliary device to a processor element in the subsea fixture or a processor element connected to the electronic auxiliary device via the flying lead.

19. The method as claimed in claim 16, further comprising:
wirelessly communicating between the electronic auxiliary device and a sensor remote from the electronic auxiliary device via acoustic and/or optical and/or radio frequency wireless communication.

20. A method of retrieving and/or replacing a subsea adaptor comprising a housing containing a first electronic auxiliary device and at least one wet mate receptacle connector and at least one wet mate plug connector, comprising the steps of:
via an ROV or AUV or diver, disconnecting a flying lead terminated in a flying lead wet mate plug connector from a first housing containing an associated first electronic auxiliary device;
disconnecting the first housing from a subsea fixture by unsecuring a housing wet mate plug connector from a subsea fixture wet mate receptacle connector; and
retrieving the first housing via the ROV or AUV or diver and/or replacing the first housing with a further housing containing an associated at least one further electronic auxiliary device via the ROV or AUV or diver.
